(19) United States
(12) Patent Application Publication
(10) Pub. No.: US 2006/0135155 A1
(43) Pub. Date: Jun. 22, 2006

(54) Method for roaming authentication in public wireless LAN

(75) Inventors: Yu-Yen Chung, Changhua City (TW); Tien-Chih Wang, Sanjhih Township (TW)

Correspondence Address: BACON & THOMAS, PLLC, 625 SLATERS LANE, FOURTH FLOOR, ALEXANDRIA, VA, 22314, US

(73) Assignee: Institute For Information Industry, Taipei City (TW)

(21) Appl. No.: 11/115,265

(22) Filed: Apr. 27, 2005

(30) Foreign Application Priority Data
Dec. 20, 2004 (TW) 093139681

(51) Int. Cl. H04Q 7/20

(52) U.S. Cl. 455/432.1

(57) ABSTRACT

A method for roaming authentication in a public wireless LAN is disclosed, which uses an identical authentication page provided from a central roaming center to provide roaming authentication process. A user that wants to roam in the WLAN must propose an address or words related to the roaming center on the browser in advance in order to directly login the authentication page provided from the roaming center through an access controller. After the roaming center receives the authentication information from the user, it will verify the identity with home authentication server; if it is successful in verifying the identity, the user can have the privilege of access to the Internet via roaming.

### BACKGROUND OF THE INVENTION

1. Field of the Invention

The present invention relates to a method for roaming authentication and, more particularly, to a method for roaming authentication in a public wireless LAN.

2. Description of Related Art

Generally, when a user wants to access the Internet via the wireless LAN (WLAN), the wireless terminal device, such as a personal computer, laptop computer (notebook) or cellar phone, which the user operates has to be equipped with a WLAN card for communicating with a neighboring wireless access point (AP), also known as a hot spot, to access the Internet.

In many public environments, such as coffee shops, department stores, or subway stations, a number of wireless AP may be established which provide an authentication, authorization and accounting (AAA) mechanism for authenticating a user's identity, charging the user and granting the access on the Internet.

With reference to FIG. 1, there is shown a graph illustrating a method for identifying a user by an authentication of universal access method (UAM). When a user brings a laptop computer 11, and uses a WLAN card 111 which is configured in the laptop computer 11, to communicate with the neighboring wireless AP 12, the user may open a browser and key in a network address for opening the web page according to the network address.

At that time, an access controller 13 will force the user redirect to an authentication page for providing the user's personal information (e.g., account, password) if the user has not been verified. Thereafter, the access controller 13 receives the identity information from the user and it will transfer the identity datum to an AAA server 14, for processing authentication.

Usually, the AAA server 14 would store a plurality of users' information including users' accounts, basic information, and users' authorizations. Therefore, when the AAA server 14 receives the authentication information from the access controller 13, it will compare the received datum with that which has been stored to verify if the user has permission to access the Internet 16, and then feedback the result of the verification to the access controller 13. If the access controller 13 grants the user access to the Internet 16, the user can connect the Internet 16 through the WLAN card 111, the wireless AP 12 and a gateway 15.

However, a user may use the WLAN service from the A1 Internet service provider (ISP), but connect the AP from the B1 ISP. Since the B1 ISP has no authentication information of the user, the user can't access the Internet without a roaming mechanism. Currently, there are two primary types of user interface for WLAN: UAM and smart client.

The UAM indicates that each hot spot provides an authentication page to the user so that the user can register different pages that are provided from different system providers to access the Internet. However, it is not user-friendly for a roaming user that needs to register on different pages if connecting on different hot spots from different system providers. In addition, it might be dangerous to the security if the malicious or illegal hot spot system provider exposes the user's personal information.

The smart client indicates that the authenticating software is provided from the roaming system provider. After users install it, the software would automatically process the authentication wherever roaming on the different hot spots from different system providers. However, the user has to install the extra software, and the cost is greater for the roaming system providers to develop the specified protocols, software, and the access controller to coordinate with the smart client.

Therefore, it is desirable to provide a method to mitigate and/or obviate the aforementioned problems.

### SUMMARY OF THE INVENTION

The first object of the present invention to provide a method which provides a simple and easy way for roaming authentication in a public WLAN, such that a user does not need to install the extra software, and only needs to use a browser for authentication.

It is another object of the present invention to provide a method, which provides ensured security for roaming authentication in a public WLAN, such that a user can login on an identical interface even when connecting on different hot spots from different system providers.

It is another object of the present invention to provide a method, which provides a way for roaming authentication in a public WLAN, such that a user can know if a hot spot can support roaming without difficulty.

It is another object of the present invention to provide a method, which provides a way for roaming authentication in a public WLAN, such that the user does not need to worry about the malicious or illegal hot spot system provider exposing the authentication information, and stops information being acquired by a rogue AP.

In one aspect of the invention, a method for roaming authentication in a public WLAN which operates with a client, an access controller, a roaming center and a home authentication server is provided. The method comprises the steps of: a requesting step, proposing a request formed with a predetermined words from the client, and transferring the request to the access controller from the client; a providing authentication page step, wherein the request can pass through the access controller, and enable the roaming center to provide an authentication page to the client; a verifying step, wherein the home authentication server verifies the identity information of the client transferred from the roaming center; and a responding step, wherein the roaming center returns a verification page to the client.

In another aspect of the invention, a method for roaming authentication in a public WLAN which operates with a client, an access controller, a roaming center and a home authentication server is provided. The method comprises the steps of: a requesting step, proposing a request formed with a predetermined words from the client, and transferring the request to the access controller from the client, wherein the predetermined words are the network address of the roaming center; a providing authentication page step, wherein the request formed with the predetermined words can pass through the access controller, and can be directly sent to the roaming center from the access controller without passing through a visited authentication server so that the roaming center provides an authentication page to the client; a verifying step, wherein the home authentication server verifies the identity information of the client transferred from the roaming center; and a responding step, wherein the roaming center returns a verification page to the client.

In another aspect of the invention, a method for roaming authentication in public WLAN is provided. The method comprises the steps of: a requesting step, proposing a request formed with predetermined words; a providing authentication page step, wherein a third party provides an authentication page based on the request formed with the predetermined words, wherein the third party is not a visited authentication server; a verifying step, wherein the third party transfers the identity information to a home authentication server for verifying; and a responding step of returning a verification result to the client.

Other objects, advantages, and novel features of the invention will become more apparent from the following detailed description when taken in conjunction with the accompanying drawings.

### BRIEF DESCRIPTION OF THE DRAWINGS

FIG. 1 shows a diagram of a method illustrating the authentication of the universal access method (UAM), for identifying a user that uses the wireless terminal device to connect the Internet;

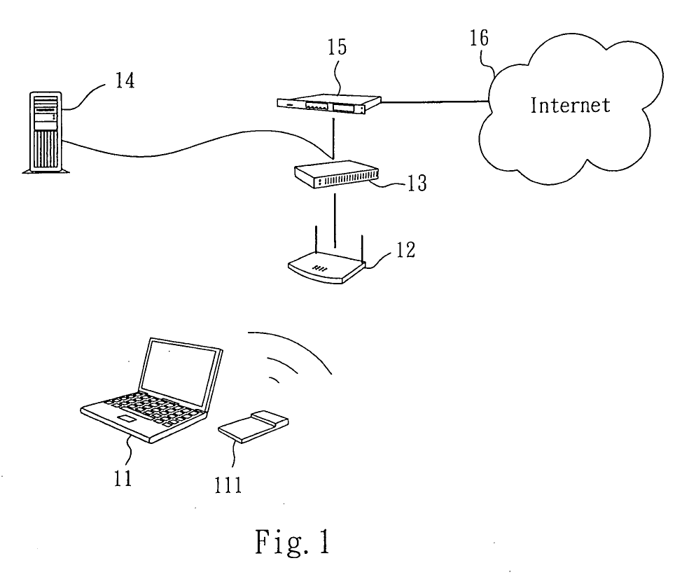

FIG. 2 shows a flow chart of a preferred embodiment in the present invention; and

FIG. 3 shows a message flow chart of a preferred embodiment in the present invention.

### DETAILED DESCRIPTION OF THE PREFERRED EMBODIMENT

The present invention is generally directed to a method using an identical and ensured security authentication webpage for authenticating roaming users that is provided from a central roaming center; the roaming center may be a specified organization, corporation or company that can exchange messages with a plurality of Internet service providers (e.g., an ISP, or an application service provider (ASP)). Since present invention provides an identical authentication page, a user needs to propose the predetermined words to a browser in advance when accessing the Internet using the specified roaming mechanism. For example, the predetermined words can be the network address of the roaming center. Since the predetermined words are special and defined in advance, the access controller must be capable of recognizing the predetermined words, and then pass the predetermined words to the roaming center. Thereafter, the user can process the roaming authenticating with accommodation and ensured security.

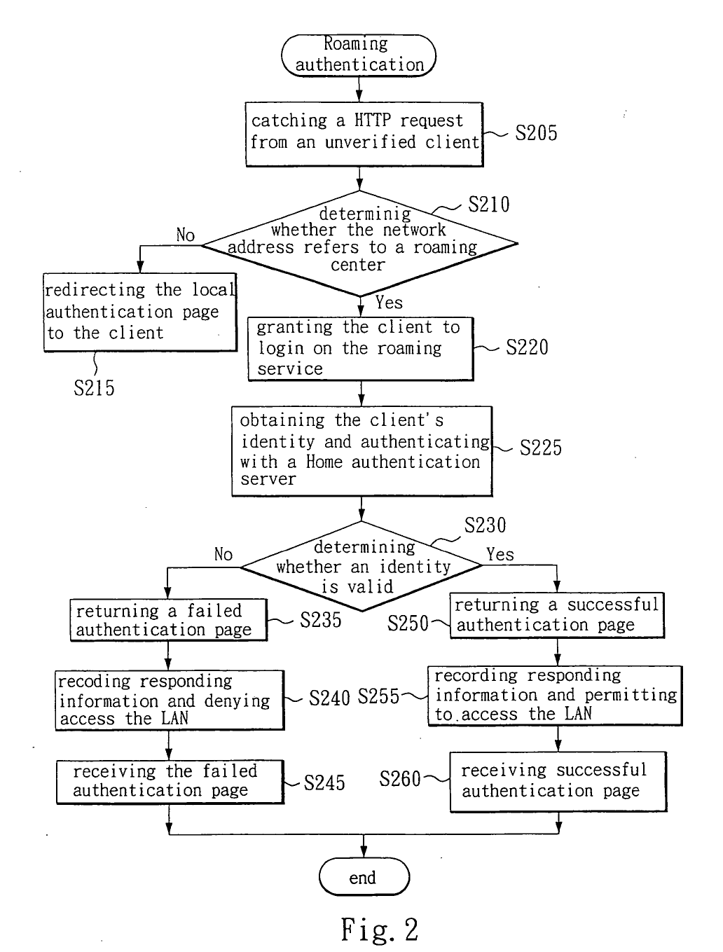

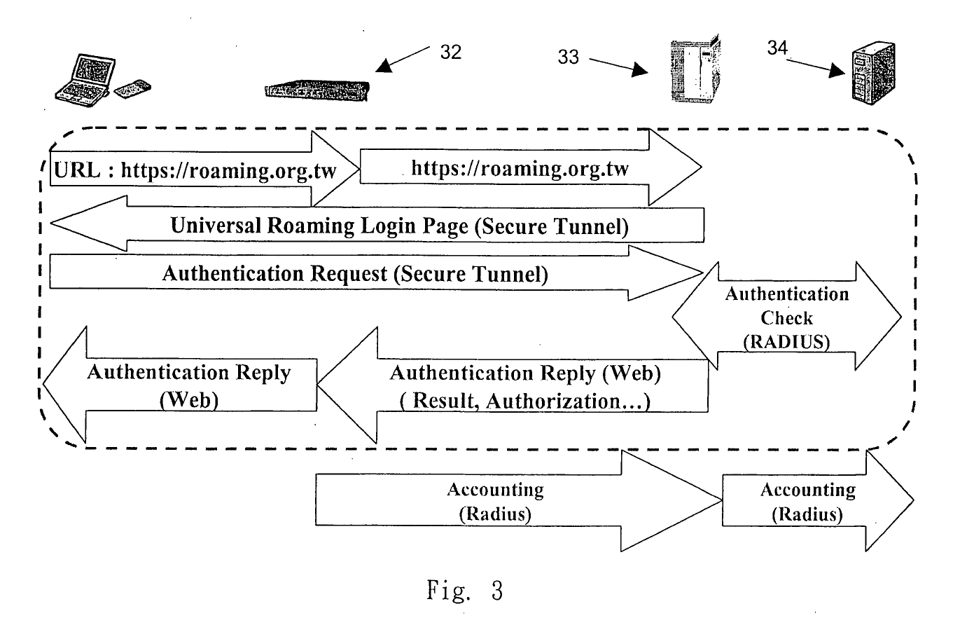

With reference to FIG. 2 illustrating the process flow of the preferred embodiment and FIG. 3 illustrating the message flow of the preferred embodiment, when a user 31 uses the WLAN service that is provided from the A1 provider, but the user 31 is within the WLAN service range from the B1 provider, then the user 31 can use the roaming authentication mechanism of the embodiment of the present invention.

First, the user 31 starts a browser on the wireless terminal device (e.g., laptop computer, personal digital assistant (PDA) or cellar phone), and then keys in the network address of the predetermined words, for example: “http://roaming.org.rw”. Thereafter, the user's wireless terminal device will transfer the HTTP request to the nearby access controller 32 via the WLAN card, and in emphasis, the access controller 32 belongs to the B1 provider. Besides, in the preferred embodiment of the present invention, the access controller 32 is established together with the access point. Moreover, in other embodiments of the present invention, the access point can be separated from the access controller 32, thus the user's wireless terminal device uses the WLAN card to connect to the nearby access point to transfer the HTTP request to the access controller 32.

Next, the access controller 32 can catch the unverified identity authentication HTTP request that is proposed from the user 31 (client) (step S205). Thereafter, the access controller 32 recognizes the HTTP request from the user 31 if it is the network address of the roaming center (step S210). If it is not, the access controller 32 will redirect the local authentication page (e.g., the authentication page that is provided from the B1 provider) to the user 31 (step S215). Since the knowledge about how the user 31 re-registers the local authenticating page is well known to one skilled in the art, a detailed description is deemed unnecessary.

If the access controller 32 recognizes the specified destination network address of the HTTP request from the user 31, as the specified network address of the roaming center 33, thus the access controller 32 admits the user 31 to connect to the roaming center 33 directly, and the HTTP request is directly delivered to the roaming center 33 without going through the visited AAA Server (e.g., the authentication server from the B1 provider). Thereafter, the roaming center 33 will grant the user 31 to login by the roaming service, and send an identical authentication page to the user 31 (step S220). Next, the user 31 receives the identical authentication page, and then proposes the personal information, such as the ISP name, the account ID and the password, and thereafter returns it to the roaming center 33. In this embodiment, the HTTP connection between the roaming center 33 and the user 31 is ensured by the security transmission channel or encryption/decryption technology, such as a secure socket layer (SSL), in order to protect the identity authentication information from the malicious or illegal service provider of the hot spot, and also provide an identical and an ensured security authentication service.

When the roaming center 33 receives the identity authentication information that the user 31 proposed on the authentication page, it processes the authentication based on the identity authentication information from the user 31 and the home authentication server 34 that the user 31 belongs to; the roaming center 33 can use the traditional protocol (e.g., RADIUS) to verify the identity with the home authentication server 34 that the user belongs to (step S225).

Thereafter, the home authentication server 34 recognizes the identity authentication information from the user 31 if it is acceptable, and returns the result to the roaming center 33. After the roaming center 33 has received the reply from the home authentication server 34, it returns a successful verification page with related service information to the user 31; the related service information is composed of the acknowledgement of the verified result and the privilege/limitation on the access controller 32 of the hot spot, etc., in a markup language including types of HTML, XML, and so on (step S230).

If the home authentication server 34 recognizes the identity of the user 31 as not an acceptable one, the home authentication server 34 returns the failed verification result to the roaming center 33. After the roaming center 33 has received the result from the home authentication server 34, it returns a failed verification page with related failed information to the user 31 (step S235). Besides, the access controller 32 records the failed verification information when it receives the result from the roaming center 33 in order not to permit the user 31 to access the Internet (step S240). Finally, the user 31 receives the failed verification page and cannot access the Internet.

If the home authentication server 34 recognizes the identity of the user 31 as an acceptable one, the home authentication server 34 returns the successful verification result to the roaming center 33. After the roaming center 33 has received the result from the home authentication server 34, it returns a successful verification page with related privilege information to the user 31 (step S250). Similarly, the access controller 32 records the successful verification information when it receives the result from the roaming center 33 in order to permit the user 31 to access the Internet within its privilege (step S255). Finally, the user 31 receives the successful verification page and can access the Internet based on its privilege.

Although the present invention has been explained in relation to its preferred embodiment, it is to be understood that many other possible modifications and variations can be made without departing from the spirit and scope of the invention as hereinafter claimed.

What is claimed is:

1. A method for roaming authentication in a public wireless LAN, which operates with a client, an access controller, a roaming center and a home authentication server, the method comprising the steps of:
a requesting step, proposing a request formed with predetermined words from the client, and transferring the request to the access controller from the client;
a providing authentication page step, wherein the request can pass through the access controller, and enable the roaming center to provide an authentication page to the client, thereby obtaining identity information of the client;
a verifying step, verifying the identity information of the client transferred from the roaming center via the home authentication server, wherein if the result of authenticating the identity of the client is successful, the home authentication server transfers a successful result to the roaming center; and
a responding step, wherein the roaming center returns a successful verification page to the client after the roaming center receives the successful result from the home authentication server.

2. The method as claimed in claim 1, wherein the predetermined words are the network address of the roaming center.

3. The method as claimed in claim 1, wherein in the requesting step, if the words of the request proposing from the client are not the predetermined words, the access controller returns a local authentication page to the client.

4. The method as claimed in claim 1, wherein in the verifying step and the responding step, if the result of authenticating the identity of the client fails, the home authentication server transfers a failed information page to the client and denies the client access to the Internet.

5. The method as claimed in claim 1, wherein the connection between the client and the roaming center is ensured by a security mechanism.

6. The method as claimed in claim 5, wherein the security mechanism is a secure tunnel capable of security.

7. The method as claimed in claim 6, wherein the secure tunnel may be a secure socket layer (SSL).

8. The method as claimed in claim 1, wherein the roaming center can communicate with a plurality of Internet service providers (ISP) or application service providers (ASP).

9. A method for roaming authentication in a public wireless LAN, which operates with a client, an access controller, a roaming center and a home authentication server, the method comprising the steps of:
a requesting step, proposing a request formed with predetermined words from the client, and transferring the request to the access controller from the client, wherein the predetermined words are the network address of the roaming center;
a providing authentication page step, wherein the request formed with the predetermined words can pass through the access controller, and can be directly sent to the roaming center from the access controller without passing through a visited authentication server so that the roaming center provides an authentication page to the client, thereby obtaining identity information of the client;
a verifying step, verifying the identity information of the client transferred from the roaming center via the home authentication server, wherein if the result of authenticating the identity of the client is successful, the home authentication server transfers a successful result to the roaming center; and
a responding step, wherein the roaming center returns a successful verification page to the client after the roaming center receives the successful result from the home authentication server.

10. A method for roaming authentication in a public wireless LAN, the method comprising the steps of:
a requesting step, proposing a request formed with predetermined words;
a providing authentication page step, wherein a third party provides an authentication page based on the request formed with the predetermined words, wherein the third party is not a visited authentication server;
a verifying step, wherein if the authentication page is filled out, the third party transfers the identity information to a home authentication server for verifying; and
a responding step, wherein if the result of authenticating the identity information is successful, the third party returns a response to grant access to the Internet.

11. The method as claimed in claim 10, wherein the third party is a roaming center.

12. The method as claimed in claim 11, wherein the roaming center can communicate with a plurality of Internet service providers (ISP) or application service providers (ASP).

13. The method as claimed in claim 10, wherein the request with the predetermined words is the network address of the third party.
